(19) United States
(12) Patent Application Publication
(10) Pub. No.: US 2009/0107339 A1
(43) Pub. Date: Apr. 30, 2009

(54) Gas Treating Apparatus

(76) Inventors: Yukihiro Aizawa, Tsukuba-shi (JP); Tooru Nagasaka, Ushiku-shi (JP)

Correspondence Address: NIXON & VANDERHYE, PC, 901 NORTH GLEBE ROAD, 11TH FLOOR, ARLINGTON, VA, 22203, US

(21) Appl. No.: 11/887,273

(22) PCT Filed: Mar. 24, 2006
(86) PCT No.: PCT/JP2006/305973

§ 371 Date: Sep. 27, 2007

(30) Foreign Application Priority Data
Mar. 28, 2005 (JP) 2005-092805

(51) Int. Cl. B01D 53/82

(52) U.S. Cl. 96/107

(57) ABSTRACT

An apparatus for treating gas by using a filler is provided, for example, using an agent for detoxicating a waste gas which includes toxic substances such as silane, phosphine, hydrogen chloride, dichlorosilane, ammonia and/or various gases used in a semiconductor manufacturing process, a liquid crystal display element manufacturing process or the like. A detoxicating agent layer is provided in a flow path within a gas treating column, and ring-shaped baffle plates are provided so as to contact the upstream surface and the downstream surface of the detoxicating agent layer, with the outer edge of the baffle plate making contact with the wall of the flow path. A width of the baffle plate is set to not smaller than five times the outer diameter of the filler and not larger than 9% of the inner diameter of the gas treating column when the outer diameter di of the filler and inner diameter D of the gas treating column satisfy a relation of 5di≦0.09D, and is set to not smaller than 2% and not larger than 9% of the inner diameter of the gas treating column when a relation of 5di>0.09D is satisfied.

### TECHNICAL FIELD

The present invention relates to an apparatus for treating gas by using a filler, for example, a gas treating apparatus that uses a detoxicating agent to neutralize a waste gas which includes toxic substance such as silane, phosphine, hydrogen chloride, dichlorosilane, ammonia and/or various semiconductor material gases used in semiconductor manufacturing process, liquid crystal display element manufacturing process and the like.

### BACKGROUND ART

To remove particular component from a gas, such a method is employed as the gas is passed through an apparatus filled with a filler which has affinity with the component or reacts chemically with the component, so as to remove the component from the gas through interaction of the component and the filler.

For example, waste gases discharged from various semiconductor manufacturing processes are being treated to be neutralized. Waste gas discharged from an apparatus which utilizes semiconductor material gas includes unreacted semiconductor material gas and/or reaction products. Since such semiconductor material gas and the reaction products are often highly harmful to the human body, they are neutralized by waste gas treating apparatus before being released to the atmosphere.

A known example of such waste gas treating apparatus is a dry scrubber. In the dry scrubber, waste gas including toxic substance is introduced into a gas treating column filled with a solid detoxicating agent, so as to remove or neutralize the toxic substance by making use of chemical or physical effect of affinity between the toxic substance and the detoxicating agent, thereby detoxicating the waste gas.

In a filler layer comprising a granular filler such as a detoxicating agent packed in a gas treating column as in the waste gas treating apparatus described above, “wall effect” is known which causes uneven distribution of void ratio in the filler layer due to the presence of the wall of the gas treating column. In the region near the wall, the filler particles exist in a state of substantially point contact with each other, and therefore have a void ratio of approximately 1, which is higher than the void ratio in a region located away from the wall surface. Also, because the arrangement of the particles is restricted by the geometrical constraints, the void ratio is under the influence of this constraint so as to vary. The influence of the wall effect on the void ratio reaches over a distance of about five times the particlesize of the filler from the wall surface. FIG. 2 shows an example of void ratio distribution in a case where the gas treating column of cylindrical shape is filled with spherical particles of filler.

Usually, a gas passing through the filler layer is distributed that pressure drop in everywhere become about the same. The pressure drop of gas is small where the void ratio high or the filler layer thickness is thin. In case the filler layer has uniform thickness, for example, pressure drop of the gas becomes smaller near the wall where the void ratio is higher due to the wall effect, than in the other region. Accordingly, gas flow rate increases near the wall so that pressure drop of the gas near the wall becomes equal to the pressuredrop of gas in the other region.

To sum up, gas flow rate becomes higher near of the wall than in the other region of the filler layer due to the wall effect, thus resulting in an uneven distribution of gas flow.

Near the wall, packing density is lower than the other region due to higher void ratio. This uneven density of the filler, along with the uneven distribution of gas flow described above, causes earlier breakthrough to occur selectively in the filler layer of region near the wall than in the other region. As a result, in the case of expendable type such as a detoxicating agent, the agent is consumed unevenly which leads to a shorter service life of the agent layer.

Life of the detoxicating agent disposed near the wall is estimated to be about 75% of that in the central portion, based on the void ratio distribution in the filler layer derived from technical literature (refer to, for example, Wall Effects in Laminar Flow of Fluids through Packed Beds; AIChE J., 27, 705, 1981).

In a gas treating apparatus, the proportion of the region near the wall where the wall effect occurs becomes smaller as the ratio of the inner diameter of the gas treating column, through which the waste gas flows, to the outer diameter of the filler (inner diameter of the flow path/outer diameter of filler) becomes larger. The larger the ratio, the smaller the increase in the impurity concentration which is discharged as a result of earlier breakthrough in the region near the wall surface. Values of the ratio (inner diameter of the flow path/outer diameter of the filler) which are generally said to render the wall effect negligible are 100 and higher.

Methods proposed for mitigating the uneven distribution of flow in order to avoid earlier breakthrough include one called the semi-spherical sheet lining method (refer to, for example, “Reduction Method of Channeling the Wall of a Packed Bed”, Tomohiro Akiyama, et al.; Materia, Vol. 35, No. 4, 1996). With this method, the inner surface of the apparatus in a section thereof which is filled with the filler is lined with a sheet having semi-spherical particles of the same diameter as that of the filler particles disposed in an staggered arrangement.

A waste gas treating apparatus for a semiconductor manufacturing apparatus is required to decrease the concentration of toxic substance at the outlet to 1 ppm or less depending on the gas to be processed. This makes earlier breakthrough a serious problem. In case the method of lining with the sheet described above is applied to the waste gas treating apparatus, the sheet must be kept in close contact with the inner surface over an extended period of time, in such an environment as the temperature rises irregularly due to reaction. As a result, it is difficult to apply this method to the waste gas treating apparatus of the semiconductor manufacturing apparatus, for the consideration of safety and cost. Thus, there has been a demand for a new technology to mitigate the uneven distribution of flow in the region near the wall of the waste gas treating apparatus.

### DISCLOSURE OF THE INVENTION

The present invention has been made to solve the problem described above, and an object thereof is to provide an apparatus that treats a gas by means of a filler, for example a waste gas treating apparatus that uses a detoxicating agent to neutralize a waste gas which includes toxic substance such as silane, phosphine, hydrogen chloride, dichlorosilane, ammonia and/or various semiconductor material gases used in semiconductor manufacturing process, liquid crystal display element manufacturing process and the like.

The present invention described that solves the problems described above is:

(1) a gas treating apparatus comprising a filler layer packed in a gas treating column, with a gas being passed through the filler layer, wherein a ring-shaped baffle plate is provided on at least one of the upstream surface and the downstream surface of the filler layer;

(2) the gas treating apparatus according to (1), wherein ring-shaped baffle plates are provided on both the upstream surface and the downstream surface of the filler layer;

(3) the gas treating apparatus according to (1) or (2), wherein a width of the ring-shaped baffle plate is set to not smaller than 5 times the outer diameter di of the filler and not larger than 9% of the inner diameter of the gas treating column when the outer diameter di of the filler and inner diameter D of the gas treating column satisfy a relation of 5di≦0.09D, and is set to not smaller than 2% of the inner diameter of the gas treating column and not larger than 9% of the inner diameter of the gas treating column when a relation of 5di>0.09D is satisfied;

(4) the gas treating apparatus according to any one of (1) to (3), wherein the filler is a detoxicating agent that removes toxic substance from waste gas.

The gas treating apparatus of the present invention makes it possible to mitigate uneven distribution of gas flow in the region near the wall of the filler layer and avoid earlier breakthrough from occurring in the filler layer in the region, by controlling the gas flow rate by a simple measure of installing the baffle plate. Controlling the gas flow rate in this manner enables it to extend the service life of the filler and improve the performance of the gas treating apparatus.

Uneven distribution of gas flow can be mitigated more effectively by properly setting the width of the baffle plate, and increasing the service life of the filler further improves the performance of the gas treating apparatus.

### BRIEF DESCRIPTION OF THE DRAWINGS

FIG. 1 is a schematic sectional view showing an example of waste gas treating apparatus of the present invention.

FIG. 2 is a graph showing the void ratio distribution near the wall when the gas treating column is filled with spherical filler particles.

FIG. 3 is a streamline diagram showing the flow of gas in a detoxicating agent layer according to the present invention.

### BRIEF DESCRIPTION OF THE REFERENCE SYMBOLS

1: Gas treating column
2: Upstream pipe
3: Detoxicating agent layer
4: Support plate
5: Downstream pipe
6: Flow path
7: Baffle plate

### BEST MODE FOR CARRYING OUT THE INVENTION

The present invention will now be described in detail, taking an example in a waste gas treating apparatus that detoxicates waste gas including toxic substance. It is understood that the present invention is not limited to this example.

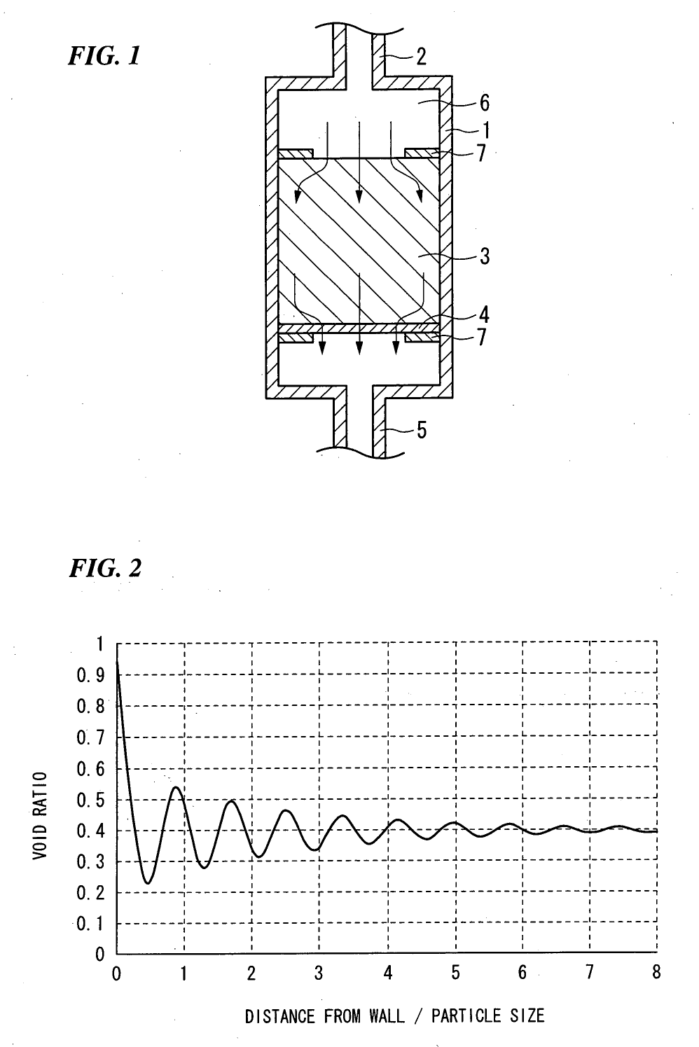

FIG. 1 shows an example of the waste gas treating apparatus of the present invention. Reference numeral 1 denotes a gas treating column which is a key component of the waste gas treating apparatus, the gas treating column having substantially cylindrical configuration with a flow path 6 through which a gas flows being formed in the gas treating column. An upstream pipe 2 is connected to one end of the gas treating column 1, and a downstream pipe 5 is connected to the other end of the gas treating column 1, so that the gas introduced through the upstream pipe 2 passes through the flow path 6 within the gas treating column 1, flows into the downstream pipe 5 and is released to the outside.

Provided downstream in the gas treating column 1 is a support plate 4 for supporting a detoxicating agent that fills the gas treating column, an outer edge of the support plate making contact with the wall of the flow path 6 so as to divide the flow path 6 into two spaces. The support plate 4 is made by attaching a metal mesh onto a punching metal by spot welding, and is installed at right angles to the center axis of the flow path 6.

The gas introduced into the flow path 6 is caused to pass through openings of the support plate 4 and flow into the downstream pipe 5.

Provided on the support plate 4 is a detoxicating agent layer 3 which is filled with the detoxicating agent, the upstream surface and the downstream surface of the detoxicating agent layer being disposed at right angles to the center axis of the flow path 6. As a result, thickness of the detoxicating agent layer 3 is constant throughout the cross section thereof.

There are ring-shaped baffle plates 7 provided on the wall of the flow path 6, one in contact with the upstream surface and the other in contact with the downstream surface of the detoxicating agent layer 3. The baffle plate 7 is formed to have a uniform width, with the outer edge making contact with the wall of the flow path 6. The baffle plate installed upstream and the one installed downstream are identical.

The baffle plate 7 installed downstream is provided below the support plate 4 in contact therewith, although this positional relationship may be reversed, so that the support plate 4 would be located below the baffle plate 7 installed downstream in contact therewith.

Alternatively, the downstream baffle plate 7 and the support plate 4 may be formed as an integral piece.

While the ring-shaped baffle plates 7 are provided on the upstream surface and the downstream surface of the detoxicating agent layer 3 in the example described above, only one baffle plate 7 may be provided on the downstream surface.

Optimum width of the baffle plate 7 was studied for achieving a proper stream of the gas through the region near the wall with the flow velocity not too high nor too slow at the upstream end of the detoxicating agent layer 3.

A technique for analyzing the gas flow through the filler layer taking the wall effect into account is described by Kler, S. C.; Lavin, J. T. in “Computer simulation of gas distribution in large shallow packed adsorbers”, Gas Separation and Purification, 1, 55-61, 1987.

A computer model was developed by adding the conditions imposed by the installation of the baffle plate, on the basis of the method of analyzing the gas flow described in this literature, and the gas flow in the detoxicating agent layer 3 was simulated.

The result of the simulation showed that uneven distribution of flow in the region near the wall can be effectively mitigated by setting the width of the baffle plate 7 as described below.

It is preferable to set the width of the ring-shaped baffle plate to not smaller than 5 times the outer diameter of the detoxicating agent and not larger than 9% of the inner diameter of the gas treating column when the outer diameter di of the detoxicating agent and the inner diameter D of the gas treating column satisfy a relation of 5di≦0.09D, and is set to not smaller than 2% and not larger than 9% of the inner diameter of the gas treating column when a relation of 5di>0.09D is satisfied.

The outer diameter used here refers to the diameter of the detoxicating agent, in case it has spherical shape. In the case of detoxicating agent having pellet shape, the outer diameter refers to equivalent diameter defined by diameter a and length b of the pellet as di=2ab/(a+b).

The gas treating apparatus of the present invention constituted as described above operates as follows.

A gas including toxic substance introduced through the upstream pipe 2 into the flow path 6 is blocked by the baffle plate 7, which is installed upstream, in the region near the wall of the flow path 6 from directly entering the detoxicating agent layer 3, so as to flow into the detoxicating agent layer 3 while skirting around the top surface of the baffle plate 7 as indicated by the arrow in FIG. 1.

While passing through the detoxicating agent layer 3, the gas is blocked by the baffle plate 7 installed downstream in the region near the wall in the detoxicating agent layer 3 from entering the flow path 6, so as to be discharged downstream of the flow path 6 skirting around the upper surface of the baffle plate 7 as indicated by the arrow in FIG. 1.

The gas introduced into the detoxicating agent layer 3 is distributed with such flow rates that cause equal pressure drop in all voids in the detoxicating agent layer 3. Pressure drop becomes smaller in a region having a higher void ratio. If the baffle plate 7 is not provided, gas flow rate increases in the region near the wall, where the void ratio is higher than in the region around the center axis of the detoxicating agent layer 3, until the pressuredrop in the region near the wall becomes equal to that in the region around the center axis, thus resulting in uneven distribution of flow.

Providing the baffle plate 7 makes it possible to prevent the gas from flowing rapidly into and out of the detoxicating agent layer in the region near the wall, so as to reduce the flow rate of the gas in the region near the wall in the detoxicating agent layer 3 where the void ratio is higher, and mitigate the occurrence of uneven distribution of flow.

The gas that has entered from upstream of the flow path 6 into a region around the center axis of the detoxicating agent layer 3 passes straight through the detoxicating agent layer 3, so as to be discharged downstream of the flow path 6 as indicated by the arrow in FIG. 1. On the other hand, a part of the gas that has entered into the detoxicating agent layer 3 along the inner edge of the baffle plate 7 installed upstream flows near the wall and along the inner edge of the baffle plate 7 installed downstream so as to be discharged downstream of the detoxicating agent layer 3 in the flow path 6. As a result, the gas flowing near the wall in the detoxicating agent layer 3 must travel over a longer distance within the detoxicating agent layer 3 than the gas flowing in the region around the center axis of the detoxicating agent layer 3, and is therefore flows at a lower flow rate in the region near the wall in the detoxicating agent layer 3, thus mitigating the occurrence of uneven distribution of flow.

With the effect described above, earlier breakthrough can be suppressed from occurring in the region near the wall in the detoxicating agent layer 3.

The gas introduced into the detoxicating agent layer 3 undergoes removal or detoxication of toxic substance while passing through the detoxicating agent layer 3, before passing the downstream pipe 5 and being discharged to the outside.

Type of the detoxicating agent may be selected in accordance to the type of toxic material to be removed.

Table 1 shows the relationship between the ratio of mean velocity of gas flow in the detoxicating agent layer 3 and the velocity of gas flow introduced into the detoxicating agent layer 3 and the ratio c of width of the baffle plate 7 to the inner diameter of the gas treating column 1, determined by simulation. The mean velocity of gas flow increases as the width of the baffle plate 7 is increased, thus indicating that the width of the baffle plate 7 must be properly selected.

TABLE 1

| | Ratio of mean velocity of |
|---|---|
| Ratio c (%) of width of | gas flow in the detoxicating |
| the baffle plate 7 to | agent layer 3 and the velocity |
| to the inner diameter of | of gas flow introduced into the |
| the gas treating column 1 | detoxicating agent layer 3 |
| 1 | 1.02 |
| 2 | 1.04 |
| 3 | 1.07 |
| 4 | 1.09 |
| 5 | 1.12 |
| 6 | 1.15 |
| 7 | 1.18 |
| 8 | 1.21 |

The results of simulating the gas flow in the detoxicating agent layer 3 under the following conditions will now be described.

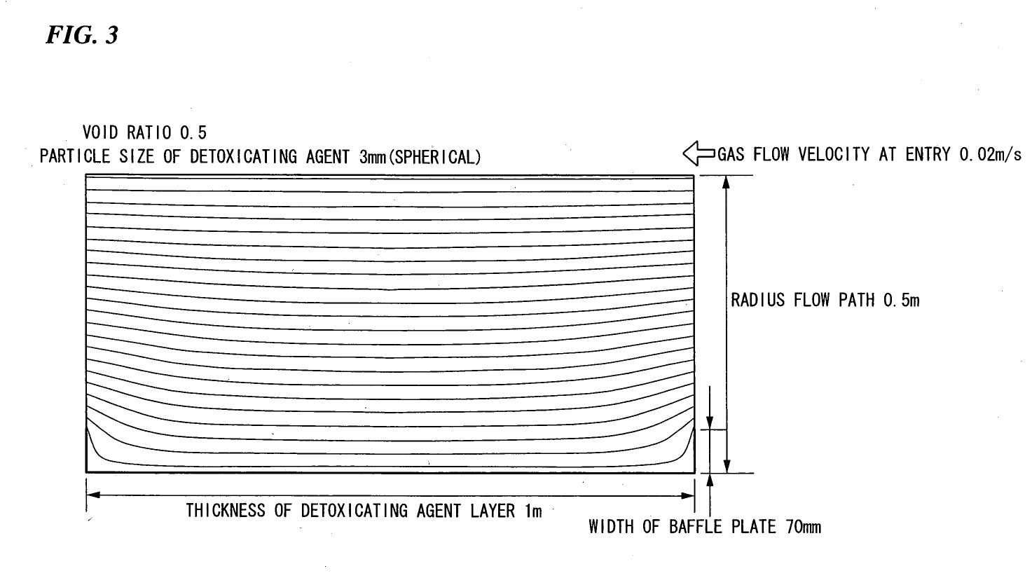

A nitrogen gas was introduced at a velocity of 0.02 m/s into the detoxicating agent layer 3 having a thickness of 1 m and void ratio of 0.5, with the detoxicating agent particles having outer diameter of 3 mm, the baffle plate 7 having width of 70 mm and the gas treating column 1 having inner diameter of 1 m. Streamlines of the nitrogen gas in the detoxicating agent layer 3 under these conditions are shown in longitudinal sectional view of FIG. 3. Since the streamlines of the gas are symmetrical with respect to the center axis, only one half on the right-hand side is shown in FIG. 3.

As can be seen in FIG. 3, the gas flowing near the wall in the detoxicating agent layer 3 travels over a longer distance than in the region around the center axis, and no disturbance is generated in the gas flow.

The gas treating apparatus of the present invention is capable of treating various waste gases by using various fillers, and is particularly suited in treating waste gas which includes toxic substance such as silane, phosphine, hydrogen chloride, dichlorosilane, ammonia and/or various gases used in a semiconductor manufacturing process, a liquid crystal display element manufacturing process or the like, for which stringent regulations are applied to the emission thereof.

### INDUSTRIAL APPLICABILITY

The gas treating apparatus of the present invention can prevent the detoxicating agent from undergoing earlier breakthrough, and is therefore suited to detoxication of waste gas from semiconductor manufacturing process, liquid crystal display element manufacturing process and the like, for which stringent regulations are applied to the emission thereof. The gas treating apparatus is useful in various fields of industry, as well as that described above, since it can be implemented at a lower cost and more easily than other methods of gas treatment that use various fillers, not the detoxicating agent.

1. A gas treating apparatus comprising a filler layer packed in a gas treating column, with a gas being passed through the filler layer, wherein a ring-shaped baffle plate is provided on at least one of upstream surface and downstream surface of the filler layer.

2. The gas treating apparatus according to claim 1, wherein ring-shaped baffle plates are provided both on the upstream surface and on the downstream surface of the filler layer.

3. The gas treating apparatus according to claim 1, wherein a width of the ring-shaped baffle plate is set to not smaller than 5 times the outer diameter of the filler and not larger than 9% of the inner diameter of the gas treating column when the outer diameter di of the filler and the inner diameter D of the gas treating column satisfy a relation of 5di≦0.09D, and is set to not smaller than 2% and not larger than 9% of the inner diameter of the gas treating column when a relation of 5di>0.09D is satisfied.

4. The gas treating apparatus according to claim 1, wherein the filler is a detoxicating agent that removes toxic component from the waste gas.
